(19) United States
(12) Patent Application Publication
(10) Pub. No.: US 2010/0259781 A1
(43) Pub. Date: Oct. 14, 2010

(54) SYSTEM AND METHOD FOR REMOTE RENDERING OF ELECTRONIC DOCUMENTS ON THE GO

(76) Inventor: Nhat Q. NGUYEN, Garden Grove, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/421,004

(22) Filed: Apr. 9, 2009

(51) Int. Cl. G06F 3/12

(52) U.S. Cl. 358/1.15

(57) ABSTRACT

The subject application is directed to a system and method for remote rendering of electronic documents. Electronic documents are stored in a data storage of a networked workstation, and a mobile document rendering selection is received. Electronic document output data is communicated to the first of a plurality of rendering devices networked with the workstation, via a driver associated with a processing application on the workstation in accordance with the mobile selection, in conjunction with identification data corresponding to the document output data source. A raster image processor generates bitmapped image data of the output data from the print driver based on the mobile rendering selection and associated identification data. Bitmapped image and identification data is communicated to at least a second device for storage associated memory. Login data is received at the second device and compared with stored identification data. Tangible document output is generated via the second device of bitmapped image data based on the comparison.

### BACKGROUND OF THE INVENTION

The subject application is directed generally to dissemination of electronic documents to multiple locations. The application is particularly applicable to efficiently distributing raster image data of an electronic document from one printer to other printers so that a user may easily select login to any desired printer to secure a quick and efficient printout.

Many enterprises include workstations that are networked with two or more document rendering devices. Such rendering devices included printers, copiers, facsimile devices, or the like. A user may have a default printer to which their documents are routinely sent. However, there are times when a user may wish to secure a printout from another of the printers. This other printer may be located elsewhere on a floor, or in a different building or even in a different location. While a user may be able to select an alternative printer in advance, the user may be unaware of a particular printer that will be conveniently located for a particular use, such as a meeting or alternative work location for the user. It may be difficult or time consuming for a user to go to an alternative printer, and then find, obtain and secure a printout of a desired document.

### SUMMARY OF THE INVENTION

In accordance with one embodiment of the subject application, there is provided a system and method for remote rendering of electronic documents. At least one electronic document is stored in a data storage associated with a networked workstation. A mobile document rendering selection is received via a user interface associated with the workstation. Electronic document output data corresponding to the electronic document is communicated to a first document rendering device of a plurality of document rendering devices in data communication with the workstation, via a print driver disposed on the workstation and associated with a document processing application, in accordance with a mobile document rendering selection, in conjunction with associated identification data corresponding to a source of the electronic document output data. Bitmapped image data is generated, via a raster image processor associated with the first document rendering device, corresponding to an electronic document output data received from the print driver in accordance with the mobile document rendering selection and stored in a data storage associated with the first document rendering device, with associated identification data received from the workstation. Bitmapped image data and associated identification data is communicated from the first document rendering device to at least a second of the plurality of the document rendering devices for storage in a memory associated therewith. Login data is received via an associated user interface of at least at a second document rendering device and compared with stored identification data at least at a second document rendering device. Tangible document output is generated via at least at a second document rendering device corresponding to bitmapped image data in accordance with an output of the comparison.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for remote rendering of electronic documents according to one embodiment of the subject application;

FIG. 2 is a block diagram illustrating device hardware for use in the system for remote rendering of electronic documents according to one embodiment of the subject application;

FIG. 3 is a functional diagram illustrating the device for use in the system for remote rendering of electronic documents according to one embodiment of the subject application;

FIG. 4 is a block diagram illustrating controller hardware for use in the system for remote rendering of electronic documents according to one embodiment of the subject application;

FIG. 5 is a functional diagram illustrating the controller for use in the system for remote rendering of electronic documents according to one embodiment of the subject application;

FIG. 6 is a functional diagram illustrating a workstation for use in the system for remote rendering of electronic documents according to one embodiment of the subject application;

FIG. 7 is a block diagram illustrating the system for remote rendering of electronic documents according to one embodiment of the subject application;

FIG. 8 is a functional diagram illustrating the system for remote rendering of electronic documents according to one embodiment of the subject application;

FIG. 9 is a flowchart illustrating a method for remote rendering of electronic documents according to one embodiment of the subject application; and

FIG. 10 is a flowchart illustrating a method for remote rendering of electronic documents according to one embodiment of the subject application.

### DETAILED DESCRIPTION OF THE PREFERRED EMBODIMENT

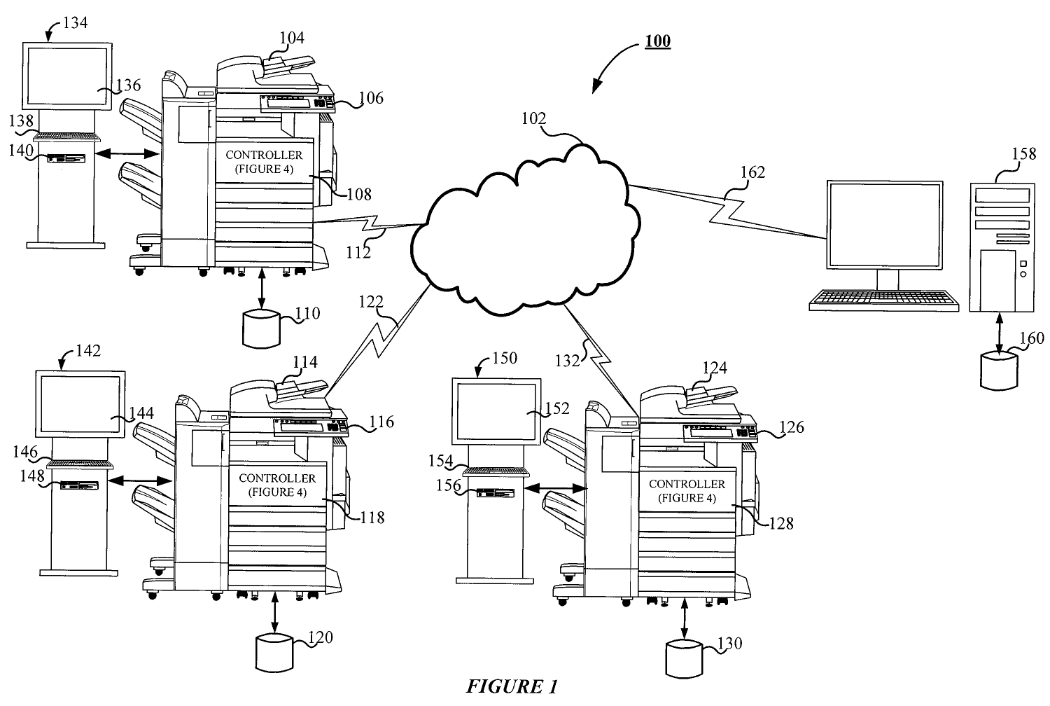

The subject application is directed to a system and method for disseminating electronic documents to multiple locations. In particular, the subject application is directed to a system and method for remote rendering of electronic documents. More particularly, the subject application is directed to a system and method that is applicable to the efficient distribution of raster image data of an electronic document from one printing device to other printing devices so that a user may easily select login to any desired printing device to secure a quick and efficient printout. It will become apparent to those skilled in the art that the system and method described herein are suitably adapted to a plurality of varying electronic fields employing remote processing, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for remote rendering of electronic documents in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1 the subject application is equally capable of use in a stand-alone system, as will be known in the art.

The system 100 also one or more document rendering devices, depicted in FIG. 1 as the document rendering devices 104, 114, and 124. As shown in FIG. 1, the document rendering devices 104, 114, and 124 are illustrated as multifunction peripheral devices, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document rendering devices include, for example and without limitation, the Toshiba e-Studio Series Controller. In accordance with one aspect of the subject application, the document rendering devices 104, 114, and 124 are suitably adapted to provide remote document rendering services to external or network devices. According to one embodiment of the subject application, the document rendering devices 104, 114, and 124 include hardware, software, and any suitable combination thereof, configured to interact with an associated user, a networked device, or the like. Preferably, the document rendering devices 104, 114, and 124 are capable of communicating electronic documents to and from each other in accordance with user provided instructions, transferring electronic documents amongst each other based upon output capabilities, locations, or the like.

According to one embodiment of the subject application, the document rendering devices 104, 114, and 124 are suitably equipped to receive a plurality of portable storage media, including, without limitation, Firewire drive, USB drive, SD, MMC, XD, Compact Flash, Memory Stick, and the like. In the preferred embodiment of the subject application, the document rendering devices 104, 114, and 124 further include associated user interfaces 106, 116, and 126, such as a touch-screen, LCD display, touch-panel, alpha-numeric keypad, or the like, via which an associated user is able to interact directly with the document rendering devices 104, 114, and 124. In accordance with the preferred embodiment of the subject application, the user interfaces 106, 116, and 126 are advantageously used to communicate information to associated users and receive selections from such associated users.

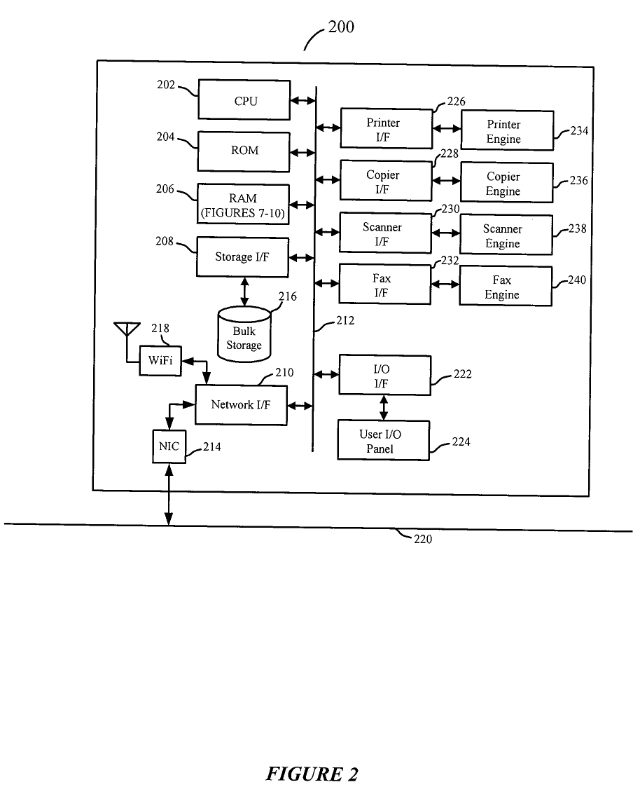

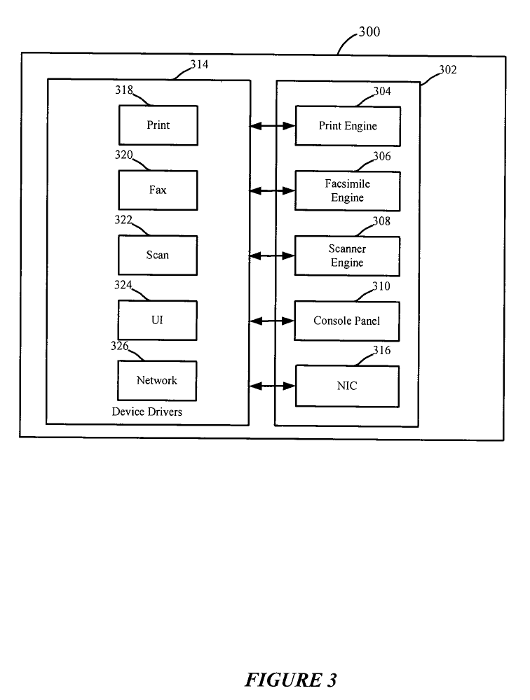

The skilled artisan will appreciate that the user interfaces 106, 116, and 126 comprise various components, suitably adapted to present data to associated users, as are known in the art. In accordance with one embodiment of the subject application, the user interfaces 106, 116, and 126 comprise a display, suitably adapted to display one or more graphical elements, text data, images, or the like, to an associated user, receive input from the associated user, and communicate the same to a backend component, such as controllers 108, 118, and 128, as explained in greater detail below. Preferably, the document rendering devices 104, 114, and 124 are communicatively coupled to the computer network 102 via suitable communications links 112, 122, and 132. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document rendering devices 104, 114, and 124 will be better understood in conjunction with the block diagrams illustrated in FIGS. 2 and 3, explained in greater detail below.

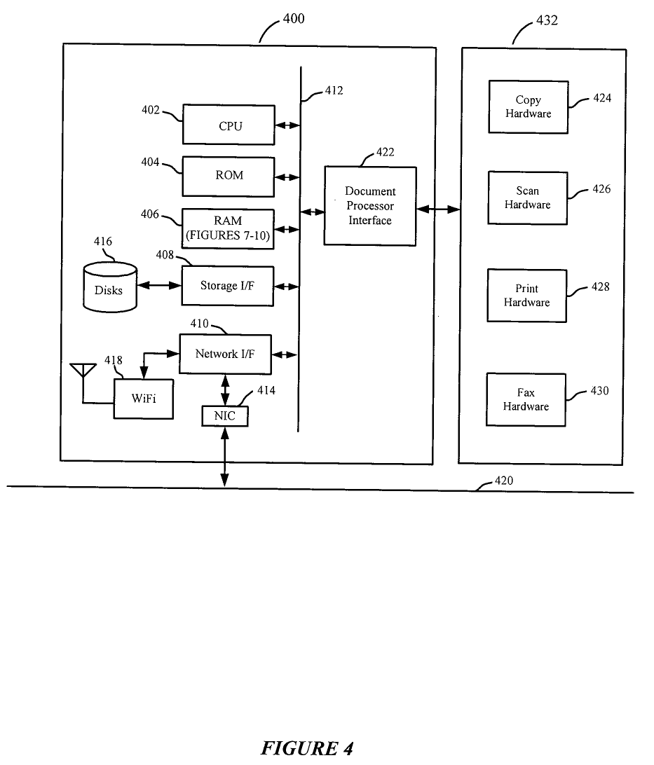

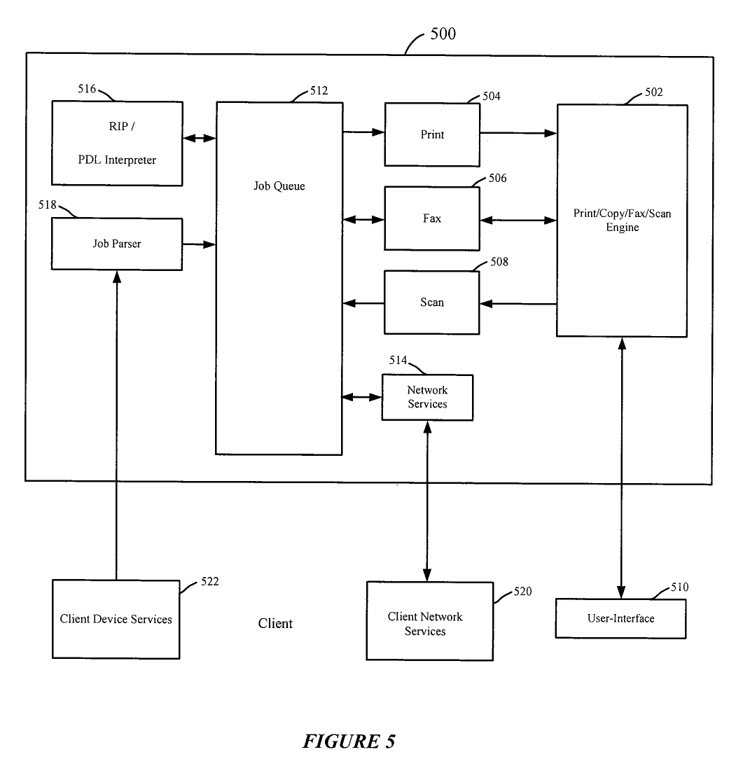

In accordance with one embodiment of the subject application, the document rendering devices 104, 114, and 124 further incorporate a backend component, designated as the controllers 108, 118, and 128, suitably adapted to facilitate the operations of their respective document rendering devices 104, 114, and 124, as will be understood by those skilled in the art. Preferably, the controllers 108, 118, and 128 are embodied as hardware, software, or any suitable combination thereof, configured to control the operations of the associated document rendering devices 104, 114, and 124, facilitate the display of images via the user interfaces 106, 116, and 126, direct the manipulation of electronic image data, maintain the security of applications, user information, data, and the like. For purposes of explanation, the controllers 108, 118, and 128 are used to refer to any myriad of components associated with the document rendering devices 104, 114, and 124, including hardware, software, or combinations thereof, functioning to perform, cause to be performed, control, or otherwise direct the methodologies described hereinafter. It will be understood by those skilled in the art that the methodologies described with respect to the controllers 108, 118, and 128 are capable of being performed by any general purpose computing system, known in the art, and thus the controllers 108, 118, and 128 are representative of such a general computing device and is intended as such when used hereinafter. Furthermore, the use of the controllers 108, 118, and 128 hereinafter is for the example embodiment only, and other embodiments, which will be apparent to one skilled in the art, are capable of employing the system and method for remote rendering of electronic documents of the subject application. The functioning of the controllers 108, 118, and 128 will better be understood in conjunction with the block diagrams illustrated in FIGS. 4 and 5, explained in greater detail below.

Communicatively coupled to the document rendering devices 104, 114, and 124 are data storage devices 110, 120, and 130. In accordance with the preferred embodiment of the subject application, the data storage devices 110, 120, and 130 are any mass storage device known in the art including, for example and without limitation, magnetic storage drives, a hard disk drive, optical storage devices, flash memory devices, or any suitable combination thereof. In the preferred embodiment, the data storage devices 110, 120, and 130 are suitably adapted to store security levels, security software, document data, image data, electronic database data, or the like. It will be appreciated by those skilled in the art that while illustrated in FIG. 1 as being a separate component of the system 100, the data storage devices 110, 120, and 130 are capable of being implemented as internal storage components of the document rendering devices 104, 114, and 124, components of the controllers 108, 118, and 128, or the like, such as, for example and without limitation, an internal hard disk drive, or the like.

Illustrated in FIG. 1 are a first kiosk 134, communicatively coupled to the first document rendering device 104, and in effect, the computer network 102, a second kiosk 142, communicatively coupled to the second document rendering device 114, and in effect, the computer network 102, a third kiosk 150 communicatively coupled to the third document rendering device 124, and in effect the computer network 102. It will be appreciated by those skilled in the art that the kiosks 134, 142, and 150 are capable of being implemented as separate component of the respective document rendering devices 104, 114, and 124, or as integral components thereof. Use of the kiosks 134, 142, and 150 in FIG. 1 are for example purposes only, and the skilled artisan will appreciate that the subject application is capable of implementation without the use of kiosks 134, 142, and 150; and the use of such kiosks 124, 142, and 150 is for one example embodiment only. In accordance with one embodiment of the subject application, the kiosks 134, 142, and 150 include respective displays 136, 144, and 152 and user input devices 138, 146, and 154. As will be understood by those skilled in the art the kiosks 134, 142, and 150 are capable of implementing a combination user input device/display, such as a touch screen interface. According to one embodiment of the subject application, the kiosks 134, 142, and 150 are suitably adapted to display selected advertisements to prospective customers, prompts to an associated user, receive instructions from the associated user, receive payment data, receive selection data from the associated user, and the like. Preferably, the kiosks 134, 142, and 150 include a magnetic card reader, conventional bar code reader, or the like, suitably adapted to receive and read payment data from a credit card, coupon, debit card, or the like.

The system 100 of FIG. 1 also includes portable storage device readers 140, 148, and 156, coupled to the kiosks 134, 142, and 150 and suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art. It will be appreciated by those skilled in the art that the illustration of kiosks 134, 142, and 150 are for example purposes only, and the subject application is capable of implementation using only the document rendering devices 104, 114, and 124, and their associated user interfaces 106, 116, and 126.

Also depicted in FIG. 1 is a computer workstation 158 in data communication with the computer network 102 via a communications link 162. It will be appreciated by those skilled in the art that the workstation 158 is shown in FIG. 1 as a workstation computer for illustration purposes only. As will be understood by those skilled in the art, the workstation 158 is representative of any personal computing device known in the art including, for example and without limitation, a laptop computer, a personal computer, a personal data assistant, a web-enabled cellular telephone, a smart phone, a proprietary network device, or other web-enabled electronic device. According to one embodiment of the subject application, the workstation 158 further includes software, hardware, or a suitable combination thereof configured to interact with the document rendering devices 104, 114, and 124, or the like. In one embodiment of the subject application, the workstation 158 includes one or more drivers suitably configured to interact with the document rendering devices 104, 114, and 124, prepare electronic documents for output thereby, and the like, as will be understood by those skilled in the art.

The communications link 162 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the workstation 158 is suitably adapted to provide document data, job data, user interface data, image data, monitor document processing jobs, employ thin-client interfaces, generate display data, generate output data, or the like, with respect to the document rendering devices 104, 114, or 124, or any other similar device coupled to the computer network 102.

Communicatively coupled to the workstation 158 is the data storage device 160. According to the foregoing example embodiment, the data storage device 160 is any mass storage device, or plurality of such devices, known in the art including, for example and without limitation, magnetic storage drives, a hard disk drive, optical storage devices, flash memory devices, or any suitable combination thereof. In such an embodiment, the data storage device 160 is suitably adapted to store electronic document data, document rendering device identification data, document rendering device drivers, and the like. It will be appreciated by those skilled in the art that while illustrated in FIG. 1 as being a separate component of the system 100, the data storage device 160 is capable of being implemented as an internal storage component of the workstation 158, or the like, such as, for example and without limitation, an internal hard disk drive, or the like.

Turning now to FIG. 2, illustrated is a representative architecture of a suitable device 200, shown in FIG. 1 as the document rendering devices 104, 114, and 124, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document rendering devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document rendering device, depicted in FIG. 1 as the document rendering devices 104, 114, and 124, for use in connection with the disclosed system. FIG. 3 illustrates suitable functionality of the hardware of FIG. 2 in connection with software and operating system functionality as will be appreciated by one of ordinary skill in the art. The document rendering device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controllers 108, 118, and 128, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document rendering device, such as the document rendering device 104, which includes the controller 400 of FIG. 4, (shown in FIG. 1 as the controllers 108, 118, and 128) as an intelligent subsystem associated with a document rendering device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document rendering devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

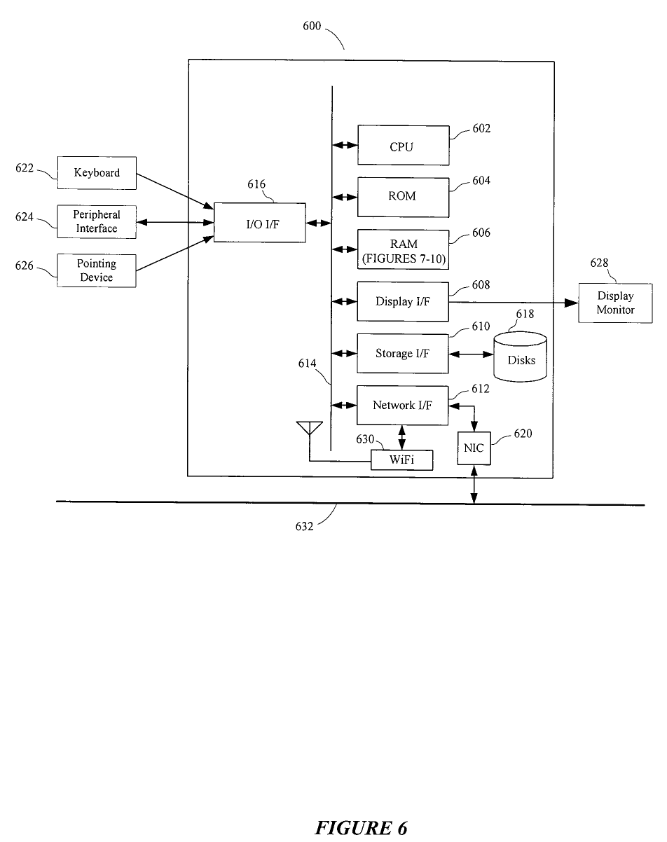

Turning now to FIG. 6, illustrated is a hardware diagram of a suitable workstation 600, shown as the computer workstation 158, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

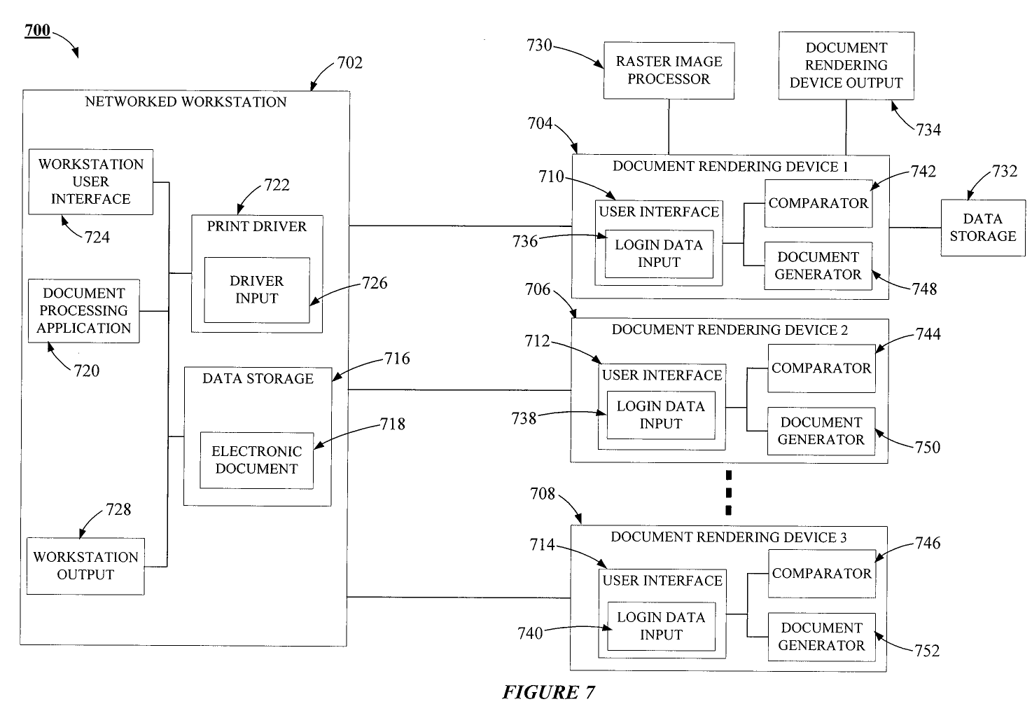

Referring now to FIG. 7, illustrated is a block diagram of a system 700 for remote rendering of electronic documents in accordance with one embodiment of the subject application. As shown in FIG. 7, the system 700 includes a networked workstation 702. The system also includes one or more networked document rendering devices 704, 706, and 708 in data communication with the workstation 702, each document rendering device 704, 706, and 708 having an associated device user interface 710, 712, and 714, respectively. The workstation includes a workstation data storage 716 that is configured to store at least one electronic document 718. The workstation 702 also includes a document processing application 720 operable on the at least one electronic document 718, and a print driver 722 associated with the document processing application 720.

The system 700 also includes a workstation user interface 724 associated with the workstation 702 and operable in connection with the print driver 722. The print driver 722 includes an associated driver input 726 operable to receive a mobile document rendering selection via the workstation user interface 724. The workstation 702 further incorporates a workstation output 728 operable to communicate electronic document output data corresponding to the at least one electronic document 718 to the first document rendering device 704 via the print driver 722, in accordance with a mobile document rendering selection, in conjunction with associated identification data corresponding to a source of the electronic document output data.

The system 700 further includes a raster image processor 730 associated with the first document rendering device 704. According to one embodiment of the subject application, the raster image processor 730 is operable to generate bitmapped image data corresponding to electronic document output data received from the print driver 722 in accordance with the mobile document rendering selection. The first document rendering device 704 further includes a data storage 732 for storing bitmapped image data and associated identification data received from the workstation 702. The document rendering device 704 also includes a document rendering device output 734 operable to communicate bitmapped image data and associated identification data to the second or third document rendering devices 706 or 708 for storage in associated memory.

The system 700 also illustrates that each user interface 710, 712, and 714 associated with each document rendering device 704, 706, and 708 includes a login input 736, 738, and 740 operable to receive login data via the associated user interface 710, 712, and 714. Each document rendering device 704, 706, and 708 includes an associated comparator 742, 744, and 746 operable to compare received login data with stored identification data. Each document rendering device 704, 706, and 708 also includes an associated document generator 748, 750, and 752 that is configured to generate a tangible document output corresponding to bitmapped image data in accordance with an output of the respective comparator 742, 744, or 746.

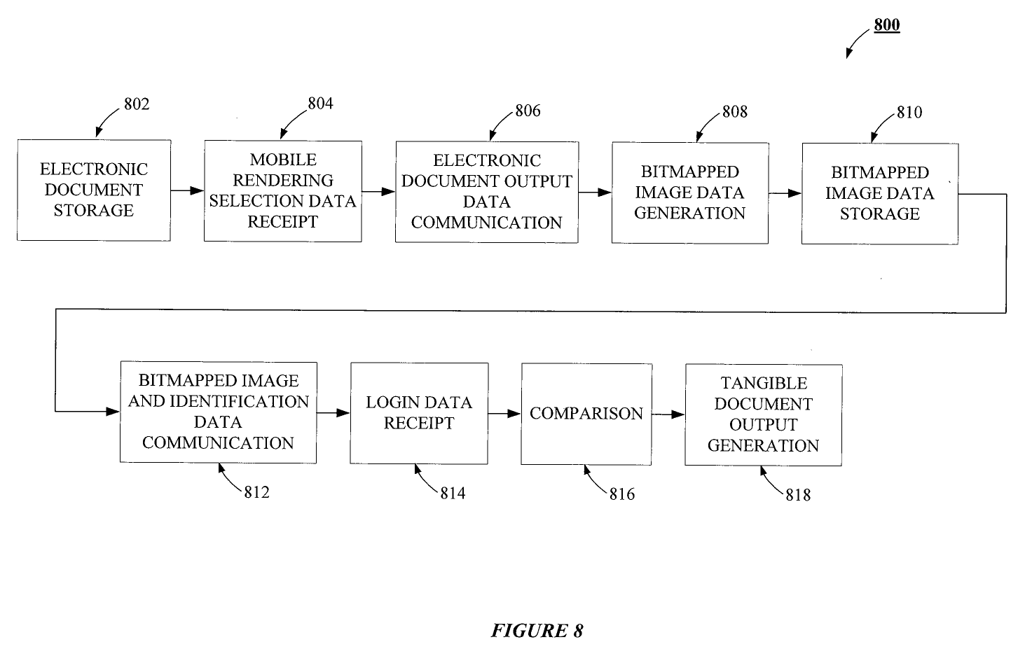

Turning now to FIG. 8, illustrated is a functional diagram of a system 800 for remote rendering of electronic documents in accordance with one embodiment of the subject application. As shown in FIG. 8, electronic document storage 802 first occurs in a data storage associated with a networked workstation. Mobile document rendering selection data receipt 804 then occurs via a user interface associated with the workstation. Electronic document output data communication 806 is then performed corresponding to the communication of the electronic document to a first document rendering device of a plurality of document rendering devices in data communication with the workstation. Such communication 806 is preferably accomplished, via a print driver disposed on the workstation and associated with a document processing application, in accordance with a mobile document rendering selection, in conjunction with associated identification data corresponding to a source of the electronic document output data.

Next, bitmapped image data generation 808 is performed via a raster image processor associated with the first document rendering device. Preferably, the bitmapped image data corresponds to an electronic document output data received from the print driver based upon the mobile document rendering selection. Bitmapped image data storage 810 then occurs of the bitmapped image data and associated identification data received from the workstation. The data storage 810 is preferably performed on a data storage associated with the first document rendering device.

Bitmapped image data and identification data communication 812 then occurs from the first document rendering device to at least a second document rendering device for storage in its associated memory. Login data receipt 814 then occurs via an associated user interface of the second document rendering device. A comparison 816 is then performed of the login data with stored identification data at the second document rendering device. Thereafter, tangible document output generation 818 is performed at the second document rendering device corresponding to bitmapped image data in accordance with an output of the comparison 816.

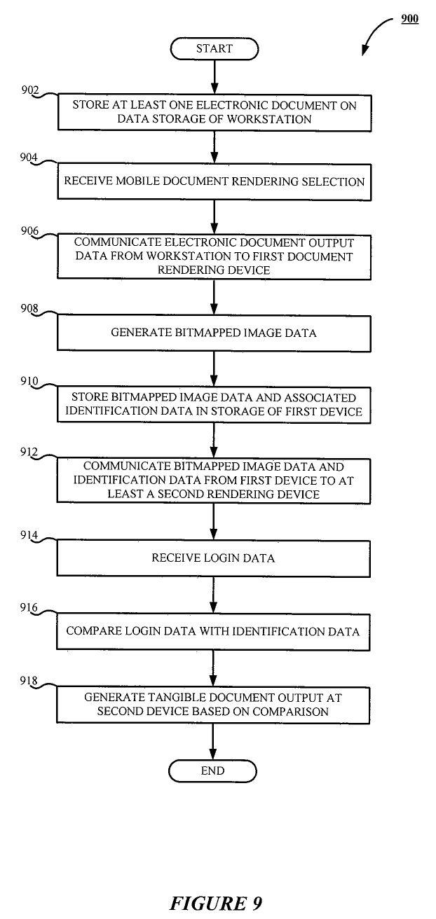

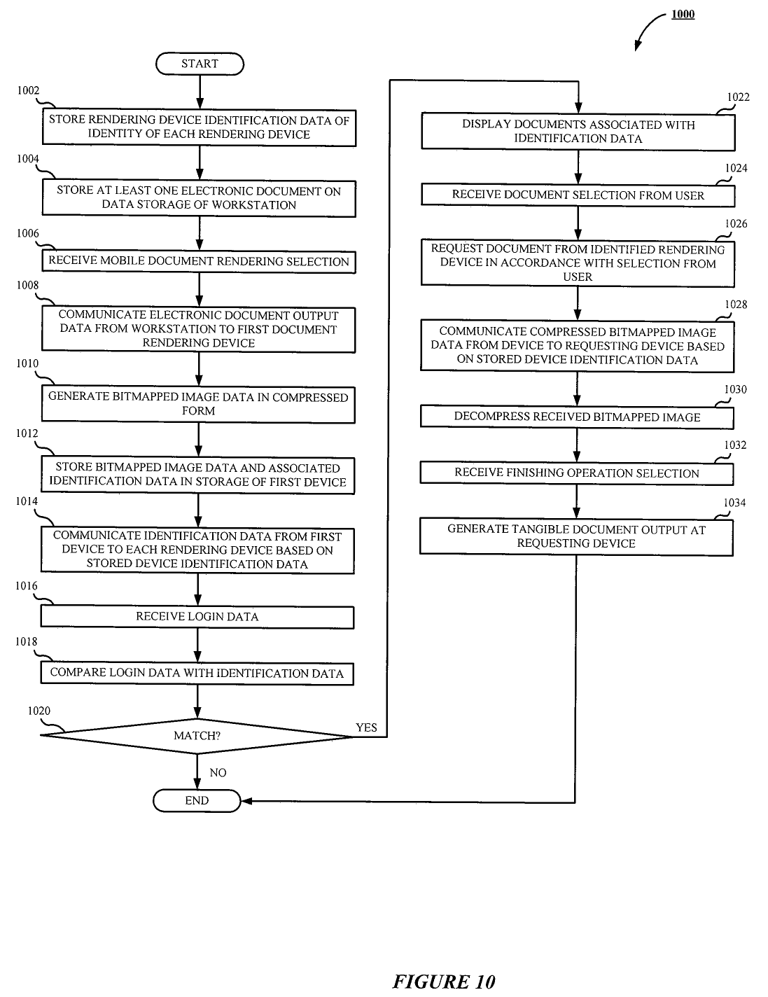

The skilled artisan will appreciate that the subject system 100 and components described above with respect to FIG. 1, FIG. 2, FIG. 3, FIG. 4, FIG. 5, FIG. 6, FIG. 7, and FIG. 8 will be better understood in conjunction with the methodologies described hereinafter with respect to FIG. 9 and FIG. 10. Turning now to FIG. 9, there is shown a flowchart 900 illustrating a remote rendering of electronic documents method in accordance with one embodiment of the subject application. Beginning at step 902, at least one electronic document is stored in a data storage 160 associated with the networked workstation 158. Next, a mobile document rendering selection is received at step 904 via a user interface associated with the workstation 158.

At step 906, electronic document output data corresponding to the electronic document is communicated from the workstation 158 to the first document rendering device 104 of the available document rendering devices 104, 114, and 124 coupled to the network 102. The skilled artisan will appreciate that the electronic document output data is communicated via a print driver disposed on the workstation 158 and associated with a document processing application, in accordance with a mobile document rendering selection, in conjunction with associated identification data corresponding to a source of the electronic document output data. A raster image processor associated with the first document rendering device 104 then generates, at step 908, bitmapped image data corresponding to the electronic document output data received from the print driver in accordance with the mobile document rendering selection.

The bitmapped image data and associated identification data received from the workstation 158 are then stored in the data storage 110 associated with the first document rendering device 104 at step 910. At step 912, the bitmapped image data and associated identification data are communicated from the first document rendering device 104 to at least one of the other available devices 114 or 124, e.g. the second document rendering device 114 for storage in its associated memory, e.g. the data storage device 120. Login data is then received via the user interface 116 or 142 associated with the second document rendering device 114 at step 914. The login data is then compared with stored identification data of the second document rendering device 114 at step 916. At step 918, tangible document output is generated at the second document rendering device 114 corresponding to bitmapped image data based upon the results of the comparison performed at step 916.

Referring now to FIG. 10, there is shown a flowchart 1000 illustrating a method for remote rendering of electronic documents in accordance with one embodiment of the subject application. The methodology of FIG. 10 begins at step 1002, whereupon rendering device identification data is stored on the data storage devices 110, 120, and 130 of each document rendering device 104, 114, and 124 corresponding to each networked device 104, 114, and 124. At step 1004, at least one electronic document is stored on the data storage 160 associated with the workstation 158. A mobile document rendering selection is then received from an associated user via a user interface associated with the workstation 158 at step 1006.

At step 1008, electronic document output data corresponding to the electronic document is communicated to the first document rendering device 104 in data communication with the workstation 158 over the computer network 102. It will be understood by those skilled in the art that the communication performed at step 1008 is accomplished via a print driver disposed on the workstation 158 and associated with a document processing application, in accordance with the received mobile document rendering selection, in conjunction with associated identification data corresponding to a source of the electronic document output data. A raster image processor associated with the first document rendering device 104, e.g. a component associated with the controller 108, or the like, then generates bitmapped image data in a compressed form at step 1010. According to one embodiment of the subject application, the bitmapped image data is generated corresponding to the received electronic document output data received from the print driver according to the mobile document rendering selection. The skilled artisan will appreciate that any suitable compression format is capable of being used in accordance with the subject application.

Bitmapped image data and associated identification data are then stored at step 1012 on the data storage device 110 associated with the document rendering device 104. Identification data from the first document rendering device 104 is then communicated to each document rendering device 114 and 124 based upon the stored rendering device identification data at step 1014. At step 1016, login data is received from a user via the user interface 116 or kiosk 142 associated with the second document rendering device 114. A comparison is then made at step 1018 between the login data and the identification data by the controller 118 or other suitable component associated with the document rendering device 114. That is, a comparison is made between the login data received from the user and the identification data that was received in association with the communication from the first document rendering device 104.

A determination is then made at step 1020 whether a match between the received login data and the received identification data has been found. When no match results from the comparison, operations terminate with respect to FIG. 10. Upon a determination at step 1020 that a match exists, flow proceeds to step 1022. At step 1022, the user interface 116, the display 144, or the like displays documents associated with the identification data to the associated user. That is, the user is presented a list of documents associated with corresponding mobile rendering selections for output by the second document rendering device 114. Document selection data is then received from the associated user corresponding to at least one of the displayed documents available for output by the document rendering device 114 at step 1024. At step 1026, the controller 118 or other suitable component associated with the second document rendering device 114 requests the selected document from the document rendering device 104 or 124 identified by the associated identification data. The skilled artisan will appreciate that the selected document is capable of having originally been sent from the workstation 158 to any of the available document rendering devices 104, 114, and 124, and thus any of the rendering devices 104, 114, or 124 is capable of requesting a document from any other device 104, 114, or 124.

At step 1028, the compressed bitmapped image data is communicated via the computer network 102 from the identified device, e.g. the first document rendering device 104, to the requesting document rendering device, e.g. the second device 114, based upon the stored device identification data. The received bitmapped image is then decompressed at step 1030 by the controller 118 or other suitable component associated with the second document rendering device 114. Finishing operation selections are then received from the associate user via the user interface 116, the kiosk 142, or the like, corresponding to one or more finishing options associated with the output of the electronic document of the decompressed bitmapped image data at step 1032. The skilled artisan will appreciate that suitable such options include, for example and without limitation, stapling, hole-punch, n-up, binding, number of copies, and the like. The second document rendering device 114 then generates a tangible document output at the second device 114 in accordance with the selected finishing options at step 1034.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for remote rendering of electronic documents comprising:
a networked workstation;
a plurality networked document rendering devices in data communication with the workstation, each document rendering device having a device user interface associated therewith;
a workstation data storage associated with the workstation, the data storage including at least one electronic document;
a document processing application disposed on the workstation and operable on the at least one electronic document;
a print driver, disposed on the workstation, associated with the document processing application;
a workstation user interface associated with the workstation and operable in connection with the print driver;
an input associated with the print driver, the input operable to receive a mobile document rendering selection via the workstation user interface;
an workstation output operable to communicate electronic document output data corresponding to the at least one electronic document to a first document rendering device of the plurality thereof, via the print driver, in accordance with a mobile document rendering selection, in conjunction with associated identification data corresponding to a source of the electronic document output data;
a raster image processor associated with the first document rendering device, the raster image processor operable to generate bitmapped image data corresponding to an electronic document output data received from the print driver in accordance with the mobile document rendering selection;
a data storage associated with the first document rendering device for storing bitmapped image data and associated identification data received from the workstation;
an output associated with the first document rendering device, the output operable to communicate bitmapped image data and associated identification data to at least a second of the plurality of the document rendering devices for storage in a memory associated therewith; an input associated with each document rendering device user interface operable to receive login data via an associated user interface;
a comparator associated with each document rendering device operable to compare received login data with stored identification data; and
a document generator associated with each rendering device operable to generate a tangible document output corresponding to bitmapped image data in accordance with an output of the comparator.

2. The system of claim 1 wherein the first document rendering device includes a data compressor operative to generate the bitmapped image data in compressed form, and wherein each of the plurality of document rendering devices includes a data decompressor operative to decompress the bitmapped image data prior to generation of the tangible document output.

3. The system of claim 1 wherein the a user interface associated with the at least a second document rendering device includes an input operative to select at least one document finishing instruction, and wherein each document rendering device is operable to generate the tangible document in accordance with a received document finishing instruction.

4. The system of claim 1 wherein the identification data is associated with the workstation.

5. The system of claim 2 further comprising rendering device identification data disposed in storage associated with each document rendering device, the device identification data including data corresponding to an identity of each of the plurality of document rendering devices.

6. The system of claim 5 wherein the first document rendering device is operative to communicate the bitmapped image data to each additional document rendering device of the plurality thereof in accordance with stored device identification data.

7. A method for remote rendering of electronic documents comprising the steps of:
storing at least one electronic document in a data storage associated with a networked workstation;
receiving a mobile document rendering selection via a user interface associated with the workstation;
communicating electronic document output data corresponding to the electronic document to a first document rendering device of a plurality of document rendering devices in data communication with the workstation, via a print driver disposed on the workstation and associated with a document processing application, in accordance with a mobile document rendering selection, in conjunction with associated identification data corresponding to a source of the electronic document output data;
generating, via a raster image processor associated with the first document rendering device, bitmapped image data corresponding to an electronic document output data received from the print driver in accordance with the mobile document rendering selection;
storing, in a data storage associated with the first document rendering device, bitmapped image data and associated identification data received from the workstation;
communicating bitmapped image data and associated identification data from the first document rendering device to at least a second of the plurality of the document rendering devices for storage in a memory associated therewith;
receiving login data via an associated user interface of at least a second document rendering device;
comparing login data with stored identification data of at least a second document rendering device; and
generating tangible document output at least at a second document rendering device corresponding to bitmapped image data in accordance with an output of the comparison step.

8. The method of claim 7 further comprising generating the bitmapped image in compressed form at the first document rendering device and decompressing the bitmapped image prior to generation of the tangible document output at least at a second document rendering device.

9. The method of claim 7 further comprising receiving at least one document finishing operation via a user interface associated with the at least a second document rendering device and generating, at least at a second document rendering device, the tangible document in accordance with a received document finishing instruction.

10. The method of claim 7 wherein the identification data is associated with the workstation.

11. The method of claim 8 further comprising storing rendering device identification data disposed in storage associated with each document rendering device, the device identification data including data corresponding to an identity of each of the plurality of document rendering devices.

12. The method of claim 11 further comprising communicating, from the first document rendering device, the bitmapped image data to each additional document rendering device of the plurality thereof in accordance with stored device identification data.

13. A system for remote rendering of electronic documents comprising:
a networked workstation;
a plurality networked document rendering devices in data communication with the workstation, each document rendering device having a device user interface associated therewith;
a data storage means associated with the workstation for storing at least one electronic document;
a document processing application disposed on the workstation and operable on the at least one electronic document;
a print driver, disposed on the workstation, associated with the document processing application;
a workstation user interface associated with the workstation and operable in connection with the print driver;
means adapted to receive a mobile document rendering selection via the workstation user interface;
means adapted for communicating electronic document output data corresponding to the electronic document to a first document rendering device of the plurality thereof, via the print driver, in accordance with a mobile document rendering selection, in conjunction with associated identification data corresponding to a source of the electronic document output data;
a raster image processor means associated with the first document rendering device for generating bitmapped image data corresponding to an electronic document output data received from the print driver in accordance with the mobile document rendering selection;
a data storage means associated with the first document rendering device adapted for storing bitmapped image data and associated identification data received from the workstation;
means adapted for communicating bitmapped image data and associated identification data from the first document rendering device to at least a second of the plurality of the document rendering devices for storage in a memory associated therewith;
an input means associated with each document rendering device user interface adapted for receiving login data via an associated user interface;
a comparison means associated with each document rendering device for comparing received login data with stored identification data; and
a document generator means associated with each rendering device for generating tangible document output corresponding to bitmapped image data in accordance with an output of the comparison means.

14. The system of claim 13 wherein the first document rendering device includes a data compression means adapted for generating the bitmapped image data in compressed form, and wherein each of the plurality of document rendering devices includes a data decompression means adapted to decompress the bitmapped image data prior to generation of the tangible document output.

15. The system of claim 13 wherein the a user interface associated with the at least a second document rendering device includes an input operative to selected at least one document finishing instruction, and wherein each document rendering device is operable to generate the tangible document in accordance with a received document finishing instruction.

16. The system of claim 13 wherein the identification data is associated with the workstation.

17. The system of claim 14 further comprising rendering device identification data disposed in storage associated with each document rendering device, the device identification data including data corresponding to an identity of each of the plurality of document rendering devices.

18. The system of claim 17 wherein the first document rendering device includes means adapted for communicating the bitmapped image data to each additional document rendering device of the plurality thereof in accordance with stored device identification data.
